(19) United States
(12) Patent Application Publication
(10) Pub. No.: US 2010/0045079 A1
(43) Pub. Date: Feb. 25, 2010

(54) ALIGNMENT SYSTEM FOR A SPACER LAYER IN A VENTILATED SEAT

(75) Inventors: Torbjorn Andersson, Trollhattan (SE); Klaus Boes, Allershausen (DE)

Correspondence Address: MACMILLAN, SOBANSKI & TODD, LLC, ONE MARITIME PLAZA-FIFTH FLOOR, 720 WATER STREET, TOLEDO, OH, 43604, US

(73) Assignee: Lear Corporation, Southfield, MI (US)

(21) Appl. No.: 12/487,986

(22) Filed: Jun. 19, 2009

(30) Foreign Application Priority Data
Aug. 19, 2008 (DE) DE 102008038380.5

(51) Int. Cl. B60N 2/56

(52) U.S. Cl. 297/180.14

(57) ABSTRACT

A ventilated vehicle seat having a foam cushion sufficient to support an occupant, the foam cushion having an outer surface; an air-permeable spacer fabric, supported on the outer surface of the foam cushion; and a fan in fluid communication with the spacer fabric. The ventilated vehicle seat characterized in that the area of the spacer fabric is less than the area of the outer surface and that the ventilated vehicle seat has an alignment system that is configured to facilitate alignment of the spacer fabric with respect to the foam cushion.

### BACKGROUND OF THE INVENTION

This invention relates in general to a vehicle seat and, more particularly, concerns a vehicle seat having an associated air-handling device connected to an air distribution system in the seat.

Motor vehicles usually have seats for the driver and any passengers. Vehicle seats are known to include a rigid frame that supports a generally horizontal lower seat assembly and a generally vertical seat back assembly. Both the lower seat assembly and seat back assembly are often cushioned with foam pads in order to make the occupant comfortable. These foam pads are covered with an upholstery layer, often made of some type of fabric, leather or synthetic material, in order to protect the foam pads from dirt and damage.

Some vehicle seats include climate control systems. These climate control systems allow the seat occupant to be made more comfortable. One type of climate controlled vehicle seat is the ventilated seat. Ventilated seats often use fans combined with channels in the foam pads to move air past the occupant or into contact with the occupant. The upholstery of a ventilated seat is either made of a fabric that air can flow through, or it is made of a material, such as leather, that is perforated in order to allow air flow.

Some ventilated vehicle seats include an air-permeable spacer layer placed between the foam pad and the upholstery layer. The spacer layer is made of a material that the air moved by the fan can easily flow through. Assembly of the ventilated seat includes proper positioning of the spacer layer on the foam pad. It would be desirable to have an improved way to properly position a spacer layer on a foam pad.

### SUMMARY OF THE INVENTION

This invention relates to a ventilated vehicle seat having a foam cushion sufficient to support an occupant, the foam cushion having an outer surface; an air-permeable spacer fabric, supported on the outer surface of the foam cushion; and a fan in fluid communication with the spacer fabric. The ventilated vehicle seat characterized in that the area of the spacer fabric is less than the area of the outer surface and that the ventilated vehicle seat has an alignment system that is configured to facilitate alignment of the spacer fabric with respect to the foam cushion.

Various aspects of this invention will become apparent to those skilled in the art from the following detailed description of the preferred embodiment, when read in light of the accompanying drawings.

### BRIEF DESCRIPTION OF THE DRAWINGS

FIG. 1 is a perspective view of a ventilated vehicle seat utilizing an alignment system of one embodiment of the invention.

FIG. 2 is a perspective view of the ventilated vehicle seat of FIG. 1 with the upholstery removed so that the spacer layer and alignment system are visible.

FIG. 3 is an exploded, perspective view of the lower seat portion of the seat of FIG. 2.

FIG. 4 is an exploded, perspective view of a lower seat cushion and spacer layer with a second embodiment of the alignment system.

FIG. 5 is an exploded, perspective view of a lower seat cushion and spacer layer with a third embodiment of the alignment system.

FIG. 6 is an exploded, perspective view of a lower seat cushion and spacer layer with a fourth embodiment of the alignment system.

### DETAILED DESCRIPTION OF THE PREFERRED EMBODIMENT

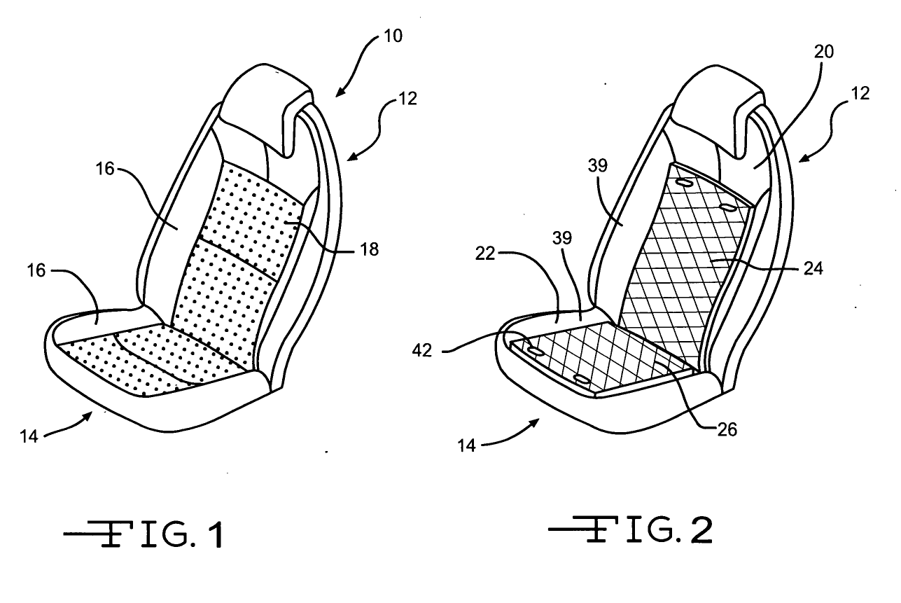

Referring now to the drawings, there is illustrated in FIG. 1 a ventilated vehicle seat 10. The ventilated vehicle seat 10 is suitable for use in the passenger compartment of a car or other vehicle. The ventilated vehicle seat 10 includes a seat back assembly, indicated generally at 12, and a lower seat assembly, indicated generally at 14. An upholstery layer 16 covers a front side of the seat back assembly 12 and the upper exterior surface of the lower seat assembly 14.

In the illustrated embodiment, upholstery layer 16 is made of leather. The upholstery layer 16 includes a perforated area 18. Perforated area 18 is included to assist in allowing air flow through upholstery layer 16. Upholstery layer 16 can be made of materials other that leather, including cloth fabric or synthetic material such as vinyl. If upholstery layer 16 is made of a material that is sufficiently permeable to air flow, then it would not be necessary to provide perforated area 18.

Referring now to FIG. 2, the ventilated vehicle seat 10 of FIG. 1 is shown with the upholstery layer 16 removed. A seat back foam cushion 20 of the seat back assembly 12 is visible, and a lower foam cushion 22 of the lower seat assembly 14 is also visible. As shown, a back spacer layer 24 is disposed between the seat back foam cushion 20 and the upholstery layer 16, and lower spacer layer 26 is disposed between the lower foam cushion 22 and the upholstery layer 16. The illustrated spacer layers 24 and 26 are made of an air-permeable material such as reticulated foam, though any air-permeable material is suitable for use as the spacer layer. Although the illustrated embodiment includes two separate spacer layers 24 and 26, it should be understood that the invention can be used with only one of the spacer layers, on either the seat back foam cushion 20 or the lower foam cushion 22. Alternatively, the invention could be used with a single spacer layer that extends over both the seat back foam cushion 20 and the lower foam cushion 22.

In the ventilated vehicle seat 10, the seat back foam cushion 20 and the lower foam cushion 22 have an outer surface 39. On the seat back foam cushion 20 the outer surface 39 is a forward surface, while on the lower foam cushion 22 the outer surface 39 is a top surface 40. The following illustrated embodiments describe the invention in conjunction with the lower foam cushion 22. However, it should be understood that the invention can also be used in conjunction with the seat back foam cushion 20.

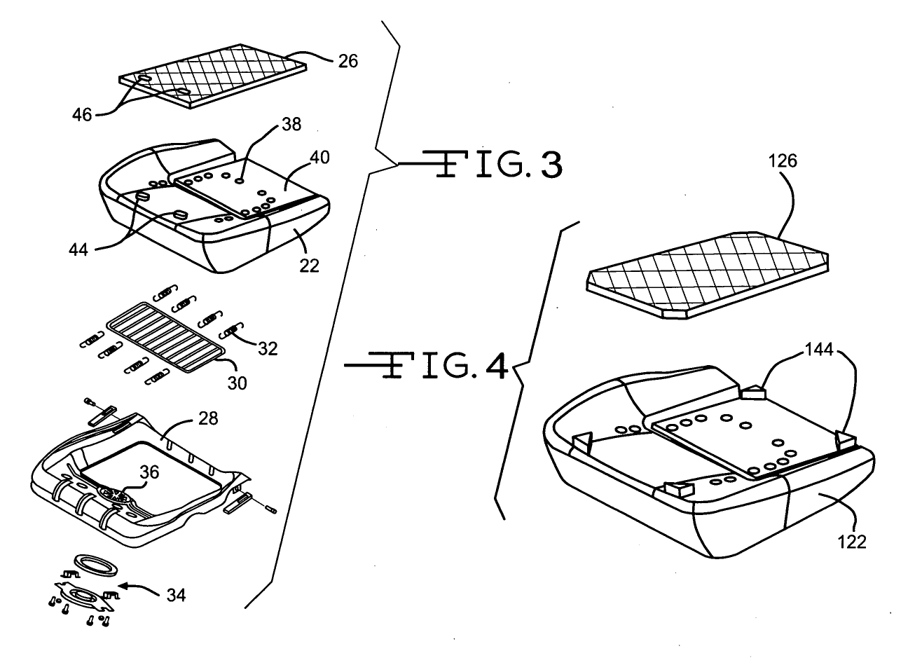

Referring now to FIG. 3, an exploded view of the lower seat assembly 14 of FIG. 2 is shown. The illustrated lower foam cushion 22 is secured atop a seat pan assembly 28. The illustrated seat pan assembly 28 is a steel component, although other materials can be used. A spring net 30 is supported by a plurality of springs 32 across the pan assembly 28 for supporting the lower foam cushion 22. A fan assembly 34 is secured to the pan opening 36 on the pan assembly 28. The lower foam cushion 22 includes a plurality of air channels 38 formed therethrough. The air channels 38 provide fluid communication between the top surface 40 of the lower foam cushion 22 and the fan assembly 34. Although FIG. 3 illustrates one embodiment of a lower seat assembly 14, the invention can be used with seat assemblies having different components or configurations. Further, the invention can be used on seat assemblies with different support systems than the illustrated pan assembly 28.

The illustrated ventilated vehicle seat 10 includes an alignment system 42 to assist in the proper placement of the lower spacer layer 26 relative to the lower foam cushion 22. Lower foam cushion 22 includes two projections 44. In the illustrated embodiment, lower foam cushion 22 is a molded part and projections 44 are molded as part of the lower foam cushion 22. This is not necessary, and lower foam cushion 22 can be created by other methods. Also, projections 44 do not have to be integral with lower foam cushion 22. Projections 44 can be glued or mechanically fastened to the lower foam cushion 22, or they can be positioned in holes in lower foam cushion 22. Projections 44 do not have to be made of the same type of material as lower foam cushion 22. Projections 44 can be made of a different type of foam, of the same material as lower spacer layer 26, or some other material. Projections 44 can be made of a material that is soft, rigid, pliable, resilient, or has other properties.

The illustrated lower spacer layer 26 defines two recesses 46. The recesses 46 correspond to the projections 44. During assembly of the vehicle seat 10, the lower spacer layer 26 can be correctly positioned on the lower foam cushion 22 by aligning the recesses 46 with the projections 44.

The air moved through the ventilated seat 10 can come from the passenger compartment of the vehicle. By circulating air from the passenger compartment, warm, humid air can be moved away from the seat occupant when it is hot. This assists in cooling the occupant through the natural sweating process. The air moved through the ventilated seat can also come from the vehicle heating and air conditioning system. This allows heated or cooled air to be brought to the material of the seat itself and more directly to the seat occupant.

The invention can be used on ventilated seat assemblies made for pushing air as well as assemblies made for pulling air. In a typical pushing air system, the fan assembly 34 forces air through air channels 38, and out through the perforated area 18 of upholstery layer 16. In a typical pulling air system, the fan assembly 34 draws air into the seat through the perforated area 18 of upholstery layer 16, through air channels 38, and the air is finally expelled from the seat.

In a pushing air system, air from the air channels 38 is able to spread out through the spacer layer 26 before passing through the perforated area 18 of upholstery layer 16. In a pulling air system, air is able to enter the spacer layer 26 through the perforated area 18 of upholstery layer 16 and travel to the air channels 38. Including the spacer layer 26 in the ventilated vehicle seat 10 reduces the likelihood of the occupant feeling cold spots on the parts of the body situated over the air channels 38. Including the spacer layer 26 also makes it less likely that an occupant of the seat will prevent air flow through the seat by obstructing all the air channels 38.

The illustrated lower foam cushion 22 includes two projections 44 corresponding to two recesses 46 on the lower spacer layer 26. It should be understood that the lower foam cushion 22 could include a greater or lesser number of projections. The illustrated projections 44 and corresponding recesses 46 have oval cross-sections. It should be understood that the projections and corresponding recesses could have a different shape. The projections and corresponding recesses could be a single, elongated shape, and can be located near the edges of the spacer layer anywhere within the spacer layer.

In an alternative embodiment, shown in FIG. 4, the foam cushion 122 includes projections 146 that correspond to the edges of the lower spacer layer 126. In the illustrated embodiment, there are four projections 146, one at each corner of the spacer layer 126. It should be understood that a different number of projections 146 could be used, and they could be located at different locations around the spacer layer 126.

In the illustrated embodiments, the recesses are shown as completely penetrating the spacer layer. This is not necessary, and the recesses could penetrate less than the full thickness of the spacer layer.

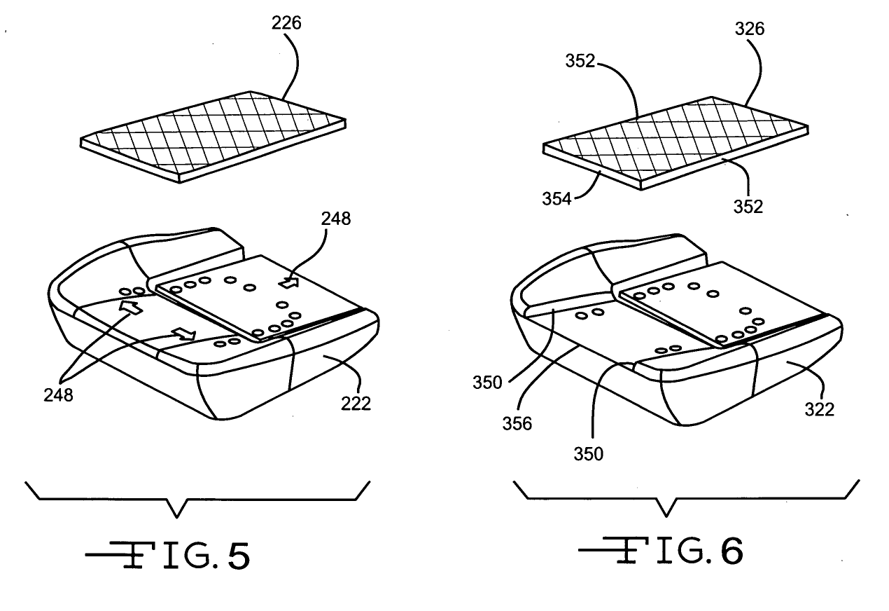

In an alternative embodiment, shown in FIG. 5, the lower foam cushion 222 includes as an alignment system a number of arrows 248. Arrows 248 provide a visual indication of the proper position of lower spacer layer 226. During assembly of the lower seat assembly 14, arrows 248 are used to assist in properly positioning the lower spacer layer 226 with respect to the lower foam cushion 222. Although the illustrated embodiment uses arrows 248 as a visual indicator, it should be understood that other visual indicators could be used, such as a colored area or different texture on lower foam cushion 222. This visual indication could be used instead of or in addition to the other alignment systems disclosed.

In an alternative embodiment, shown in FIG. 6, the lower foam cushion 322 includes ridges 350. Ridges 350 correspond to two of the edges 352 of the lower spacer layer 326. In the illustrated embodiment, the front edge 354 of lower spacer layer 326 is aligned with the leading edge 356 of the lower foam cushion 322 to properly position the lower spacer layer 326 with respect to the lower foam cushion 322. It should be understood that the ridges 350 can be configured differently than as illustrated. The ridges 350 could, for instance, provide a tapered channel that provides for proper positioning of the lower spacer layer 326 with respect to the lower foam cushion 322. Ridges 350 can be used instead of or in addition to the other alignment systems disclosed.

It should also be understood that any component of the alignment system disclosed as being installed on the lower foam cushion could be installed on the spacer layer. For instance, the lower foam cushion could include recesses and the spacer layer could include corresponding projections.

The invention has been described for use with an air-permeable spacer layer. It should use understood that the invention can also be used for positioning of air-impermeable layers, as well.

The principle and mode of operation of this invention have been explained and illustrated in its preferred embodiment. However, it must be understood that this invention may be practiced otherwise than as specifically explained and illustrated without departing from its spirit or scope.

1.-8. (canceled)

9. A ventilated vehicle seat
a foam cushion sufficient to support an occupant, the foam cushion having an outer surface;
an air-permeable spacer fabric, supported on the outer surface of the foam cushion, the air-permeable spacer fabric having an area less than the area of the outer surface;
a fan in fluid communication with the spacer fabric; and
an alignment system that is configured to facilitate alignment of the spacer fabric with respect to the foam cushion.

10. The ventilated vehicle seat of claim 9, wherein the alignment system includes one or more projections on the foam cushion and one or more recesses on the spacer fabric, wherein the recesses correspond to the projections.

11. The ventilated vehicle seat of claim 10, wherein the projections are formed as part of the foam cushion.

12. The ventilated vehicle seat of claim 9, wherein the alignment system includes a visual indicator on the foam cushion.

13. The ventilated vehicle seat of claim 12, wherein the visual indicator is a colored area.

14. The ventilated vehicle seat of claim 9, wherein the alignment system includes one or more ridges on the foam cushion, the ridges corresponding to one or more edges of the spacer fabric.

15. The ventilated vehicle seat of claim 9, wherein the alignment system includes one or more projections on the foam cushion, the projections corresponding to one or more edges of the spacer fabric.

16. The ventilated vehicle seat of claim 9, wherein the foam cushion is a lower foam cushion and the outer surface is a top surface.

17. A ventilated vehicle seat
a foam cushion sufficient to support an occupant, the foam cushion having an outer surface;
an air-permeable spacer fabric, supported on the outer surface of the foam cushion, the air-permeable spacer fabric having an area less than the area of the outer surface;
a fan in fluid communication with the spacer fabric; and
an alignment system comprising one or more projections on the foam cushion, the projections corresponding to one or more edges of the spacer fabric, the alignment system configured to facilitate alignment of the spacer fabric with respect to the foam cushion.
